(19) United States
(12) Patent Application Publication
(10) Pub. No.: US 2015/0240129 A1
(43) Pub. Date: Aug. 27, 2015

(54) ADHESIVE PAPER AND MANUFACTURING METHOD OF ADHESIVE PAPER

(71) Applicant: SEIKO EPSON CORPORATION, Tokyo (JP)

(72) Inventor: Masahide NAKAMURA, Matsumoto (JP)

(21) Appl. No.: 14/625,584

(22) Filed: Feb. 18, 2015

(30) Foreign Application Priority Data
Feb. 26, 2014 (JP) 2014-035049

(51) Int. Cl. C09J 7/04; D21H 17/20

(52) U.S. Cl. CPC C09J 7/043; D21H 17/20; C09J 2201/122; C09J 2201/61; C09J 2400/283; C09J 2499/00

(57) ABSTRACT

In an adhesive paper, paper formed by a plurality of fibers being bonded via resin is heated and adhered together, and this is peelable. The adhesive paper has resin dispersed in a thickness direction of the paper, and without having an adhesion layer on a surface of the paper, adhering is done using a portion of the resin. With the adhesive paper, the volume of resin to the fibers is 8 to 40%.

### CROSS-REFERENCE TO RELATED APPLICATIONS

This application claims priority to Japanese Patent Application No. 2014-035049 filed on Feb. 26, 2014. The entire disclosure of Japanese Patent Application No. 2014-035049 is hereby incorporated herein by reference.

### BACKGROUND

1. Technical Field

The present invention relates to adhesive paper and a manufacturing method of adhesive paper.

2. Related Art

In the past, repeelable sheets were known for which an adhesive layer was formed on the overlapping surface of a sheet, and by applying a designated pressure, the sheet overlapping surfaces were adhered together so as to be able to be peeled again (see Unexamined Patent Publication No. 2011-144312).

With the repeelable sheet disclosed in Unexamined Patent Publication No. 2011-144312, it is necessary to coat an adhesive layer on the overlapping surface of the sheet, and too many steps are required.

### SUMMARY

The present invention is created to address at least a portion of the problems described above, and can be realized as the modes or application examples noted below.

One mode of the adhesive paper of the invention is peelable adhesive paper for which paper formed by a plurality of fibers being bonded via resin is heated and adhered together.

With the invention, paper formed by bonding fibers via resin can be adhered to each other by heating them together, and it is possible to provide peelable adhesive paper.

With the adhesive paper of another mode of the invention, the resin is dispersed in a thickness direction of the paper, and no adhesion layer exists on a surface of the paper.

With the invention, by using paper with resin dispersed in the thickness direction that does not have an adhesion layer, it is possible to provide an adhesive paper for which paper can be adhered together without requiring a step of forming an adhesion layer.

With the adhesive paper of another mode of the invention, adhering can be done using a portion of the resin.

With the invention, paper is adhered together by a portion of the resin that bonds the fibers together being heated, so it is possible to provide an adhesive paper for which paper can be adhered to each other without requiring a special step such as forming an adhesion layer on the surface of the paper or the like.

With the adhesive paper of another mode of the invention, a volume of the resin to the fibers can be 8 to 40%.

With the invention, by having the volume of the resin to the fiber be 8 to 40%, it is possible to adhere paper to each other, and possible to provide peelable adhesive paper.

One mode of a manufacturing method of an adhesive paper of another mode of the invention is a manufacturing method of an adhesive paper for which paper formed by a plurality of fibers being bonded via resin is heated and adhered together.

With the invention, it is possible to adhere papers to each other by heating paper formed by bonding fibers via resin to each other, and possible to manufacture adhesive paper which can also be peeled.

### BRIEF DESCRIPTION OF THE DRAWINGS

Referring now to the attached drawings which form a part of this original disclosure:

FIG. 1 is a drawing schematically showing a paper manufacturing apparatus for manufacturing paper used for the adhesive paper of this embodiment; and

FIGS. 2A-2D are drawings showing the manufacturing procedure of a crimped postcard (one example of adhesive paper).

### DETAILED DESCRIPTION OF EXEMPLARY EMBODIMENTS

Following, we will give a detailed description of a preferred embodiment of the present invention while referring to the drawings. The embodiment described hereafter does not unreasonably limit the contents of the present invention noted in the claims. Also, all of the constitutions described hereafter are not necessarily absolutely essential constitutional elements for the present invention.

### 1. Constitution of the Paper Manufacturing Apparatus

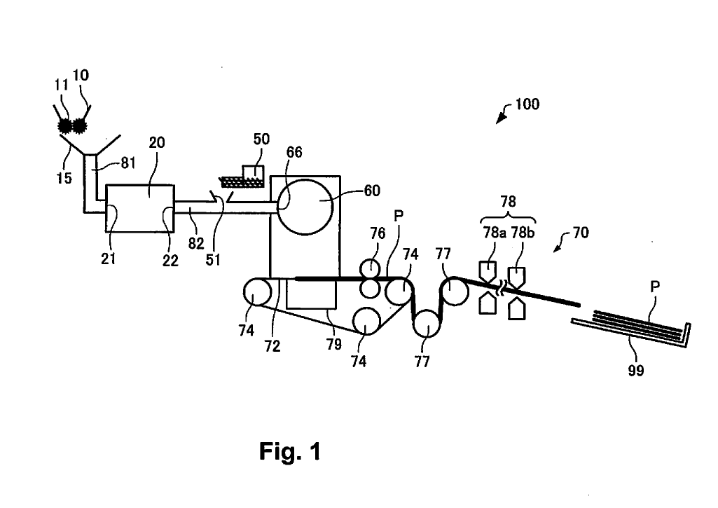

First, we will describe the constitution of the paper manufacturing apparatus for manufacturing paper used for the adhesive paper of this embodiment. FIG. 1 is a drawing schematically showing a paper manufacturing apparatus 100. The paper manufacturing apparatus 100 manufactures paper formed by bonding a plurality of fibers via resin (paper containing resin) with an item containing fiber as a raw material. The paper manufacturing apparatus 100 includes a crushing unit 10, a defibrating unit 20, a resin supply unit 50, an unraveling unit 60, and a paper forming unit 70.

The crushing unit 10 cuts (pulverizes) raw material containing fiber such as pulp sheets or input sheets (e.g. size A4 used paper) into small pieces in air. The shape and size of the small pieces are not particularly limited, and they are cut into small pieces of several cm square, for example. With the example in the drawing, the crushing unit 10 has a crushing blade 11, and it is possible to cut the input raw material using the crushing blade 11. It is also possible to provide an automatic input unit (not illustrated) for continuously inputting raw material into the crushing unit 10.

The small pieces cut by the crushing unit 10 are conveyed to a defibrating unit 20 via a first conveyance unit 81 after being received by a hopper 15. The first conveyance unit 81 is in communication with an introduction port 21 of the defibrating unit 20. The shape of the first conveyance unit 81 and a second conveyance unit 82 described later is a tube shape, for example.

The defibrating unit 20 does defibration processing of the small pieces (defibration object). The defibrating unit 20 generates disentangled fiber in fiber form by doing fibrillating processing of the small pieces.

Here, “defibration processing” means disentangling into individual fibers the small pieces made by bonding a plurality of fibers. The items that have passed through the defibrating unit 20 are called “fiber items.” In addition to disentangled fibers, the “fiber items” may also include ink particles such as ink, toner, a smudge prevention agent or the like. With the description hereafter, “fiber items” are at least a portion of the items that passed through the defibrating unit 20, and items added after passing through the defibrating unit 20 can also be mixed in.

The defibrating unit 20 does defibration processing of the small pieces introduced from the introduction port 21 using a rotary blade. The defibrating unit 20 performs fibrillation using a dry method in air. The defibrating unit 20 preferably has a mechanism that generates airflow. In this case, the defibrating unit 20, using the airflow that it generated itself, suctions small pieces from the introduction port 21 together with the airflow, does defibration processing, and is able to convey those to an exhaust port 22. The fiber items exhausted from the exhaust port 22 are conveyed to an introduction port 66 of an unraveling unit 60 via the second conveyance unit 82. A supply port 51 for supplying resin by which fibers are bonded to each other is provided on the second conveyance unit 82.

The resin supply unit 50 supplies resin in air from the supply port 51 to the second conveyance unit 82. Specifically, the resin supply unit 50 supplies resin to the path in which the fiber item faces the unraveling unit 60 from the defibrating unit 20. As the resin supply unit 50, as long as it is possible to supply resin to the second conveyance unit 82, this is not particularly limited, but a screw feeder, circle feeder or the like is used. The resin supplied from the resin supply unit 50 is resin for bonding a plurality of fibers. At the point in time that the resin is supplied to the second conveyance unit 82, the plurality of fibers are not bonded. The resin is cured when it passes through the paper forming unit 70 described later and bonds the plurality of fibers. The resin is a thermoplastic resin such as polyester resin or the like, and with the manufactured paper, is set so as to have a weight ratio of resin to fiber of 8 to 40%. In addition to the resin for bonding the fibers, a coloring agent or the like for coloring the fibers can also be supplied according to the type of paper manufactured.

The resin supplied from the resin supply unit 50 is mixed so as to be spread evenly to the fiber items exhausted from the exhaust port 22 using the mixing unit (not illustrated) provided inside the second conveyance unit 82. The mixing unit generates airflow to convey fiber items and resin to the unraveling unit 60 while mixing them.

The unraveling unit 60 unravels interwoven passed-through materials. Furthermore, the unraveling unit 60, when the resin supplied from the resin supply unit 50 is in fiber form, unravels the interwoven resin. Also, the unraveling unit 60 uniformly deposits the passed-through material and resin on a deposition unit 72 described later. In other words, the word “unravel” includes the operation of separating interwoven items and the operation of evenly depositing them. If there are no interwoven items, it is the operation of evenly depositing. As the unraveling unit 60, a sieve is used. The unraveling unit is a rotating sieve by which a net part is rotated by a motor (not illustrated). Here, the “sieve” used as the unraveling unit 60 does not have to be an item having a function for sorting specific objects. Specifically, the “sieve” used as the unraveling unit 60 means an item equipped with a net part having a plurality of openings, and the unraveling unit 60 can exhaust from the openings to the outside all of the fiber items and resin introduced to the unraveling unit 60. It is also possible to omit the unraveling unit 60 as a constitution of the paper manufacturing apparatus 100.

In a state with the unraveling unit 60 rotating, the mixture of the fiber and the resin is introduced into the unraveling unit 60 from the introduction port 66. The mixture introduced into the unraveling unit 60 is moved to the net part side by centrifugal force. As noted above, with the mixture introduced into the unraveling unit 60, there are cases when interwoven fiber or resin is contained, and the interwoven fiber or resin is unraveled in air by the rotating net part. Then, the unraveled fiber or resin is passed through openings.

The fiber items and resin that pass through the openings of the unraveling unit 60 are deposited in a state with the resin dispersed in the entire fiber item on the deposition unit 72 of the paper forming unit 70. Because of this, the resin is dispersed in the thickness direction of the deposited material. Also, resin is dispersed in the fiber item in the direction along the surface of the deposited material. The paper forming unit 70 has a deposition unit 72, a stretching roller 74, a heater roller 76, a tension roller 77, and a cutting unit 78. The paper forming unit 70 uses fiber items and resin that passed through the unraveling unit 60 to form paper.

The deposition unit 72 of the paper forming unit 70 receives the fiber items and resin that have passed through the openings of the unraveling unit 60 and deposits that to make a deposited material. The deposition unit 72 is positioned below the unraveling unit 60. The deposition unit 72 is a mesh belt, for example. A mesh is formed stretched by the stretching roller 74 on the mesh belt. The deposition unit 72 is moved by the stretching roller 74 to rotate by itself. By continuously having fiber items and resin fall and pile up from the unraveling unit 60 while the deposition unit 72 is continuously moved, a uniform thickness web is formed on the deposition unit 72.

A suction device 79 that suctions deposited material from below is provided beneath the deposition unit 72. The suction device 79 is positioned via the deposition unit 72 beneath the unraveling unit 60, and generates an air current facing downward (air current facing from the unraveling unit 60 to the deposition unit 72). By doing this, it is possible to suction the dispersed fiber items and resin in air, and possible to make the exhaust speed from the unraveling unit 60 high. As a result, it is possible to increase the productivity of the paper manufacturing apparatus 100. Also, it is possible to form a downflow of the fiber items and resin in the falling path using the suction device 79, and possible to prevent interweaving of the fiber items and resin during falling.

The fiber items and resin deposited on the deposition unit 72 of the paper forming unit 70 are heated and pressurized by passing through a heater roller 76 as the deposition unit 72 is moved. By heating, the resin functions as a bonding agent and bonds the fibers to each other, this is made thin by the pressure, this is then passed through a calendar roller (not illustrated) to smooth the surface, and paper P is formed. It is also possible to heat and pressurize by passing through the heater roller 76 after passing through the calendar roller.

Further to the downstream side than the heater roller 76, as the cutting unit 78 for cutting the paper P, arranged are a first cutting unit 78a for cutting the paper P in the direction crossing the paper P conveying direction, and a second cutting unit 78b for cutting the paper P along the paper P conveying direction. The first cutting unit 78a is equipped with a cutter, and cuts the continuous form paper P to a sheet form according to a cutting position set to a designated length. The second cutting unit 78b is equipped with a cutter that cuts according to a designated cutting position in the paper P conveying direction. By doing this, the paper is formed in a desired size. The cut paper P is stacked on a stacker 99 or the like. It is also possible to constitute this without cutting the paper, having it wound using a winding roller left in continuous form.

As described above, the method of manufacturing paper P for adhesive paper of this embodiment includes a step of fibrillating raw material containing fiber in air, and a step of forming paper P by heating a mixture of fiber and resin.

### 2. Adhesive Paper Manufacturing Method

The adhesive paper of this embodiment can be manufactured by paper P that was manufactured by the paper manufacturing apparatus 100 being adhered together by being heated and pressurized. As the heating and pressurizing means of the paper P to each other, it is possible to use a heating roller, a hot press, and electric iron or the like.

With the paper P, the resin is dispersed in the thickness direction and the direction along the surface. When the paper P is heated and pressed to each other, these are fused by the resin existing in the respective papers P, and by the resin existing on the adhesion surface side of one paper P being entwined with the fiber existing on the adhesion surface side of the other paper P (the fiber of one paper P and the fiber of the other paper P are bonded via the resin of one paper P), and the resin existing on the adhesion surface side of the other paper P being entwined with the fiber existing on the adhesion surface side of the other paper P (the fiber of one paper P and the fiber of the other paper P are bonded via the resin of the other paper P), one paper P and the other paper P are adhered.

Because there are fine bumps and dents in the surface of the paper P, with the adhesive paper of this embodiment, the papers P are only in contact with each other partially, and the fiber of one paper P and the fiber of the other paper P are bonded via the resin of a portion existing at the part that is in partial contact (papers P are partially adhered to each other). Because of that, with the adhesive paper of this embodiment, the adhesion force of the papers P to each other is weaker than the bonding force of the fibers to each other inside the paper P, so this is peelable at the adhesion surface without damaging the bond between the fibers within the paper P.

With the adhesive paper (paper P), if the weight ratio of resin to fiber is within the range of 8 to 40%, the adhesive paper is adherable and separable, but to make adhesive paper that is easily adhered and easily peeled, it is preferable to have the weight ratio of resin to fiber be about 10 to 15%. Also, for the resin mixed in the fiber when manufacturing the paper P, this can be in fiber form or in powder form, but resin melts and stretches thin due to heating when manufacturing the paper P, so it is preferable to use powder form resin. When the weight ratio of resin to fiber is less than 8%, there is insufficient strength as adhesive paper (paper P), and the adhesion force between papers P to each other is weaker. When the weight ratio of resin to fiber is greater than 40%, the adhesion force of the papers P to each other is too strong and they cannot be peeled apart.

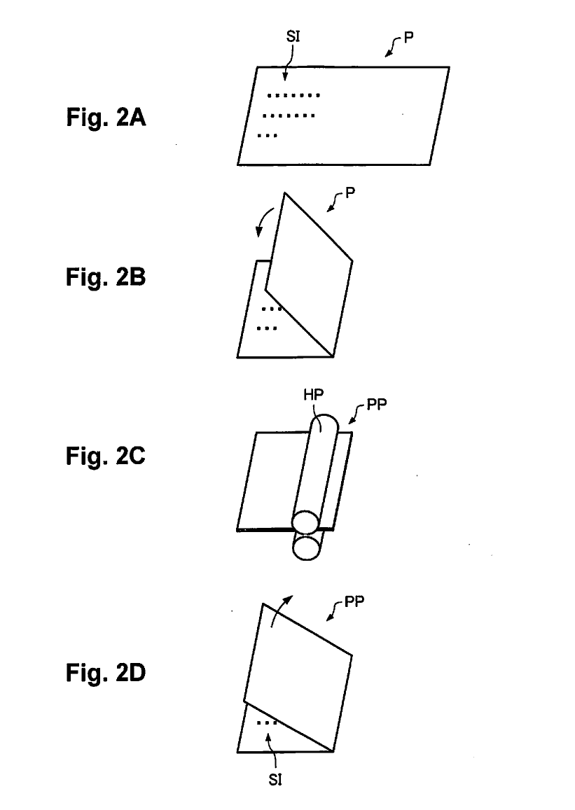

The adhesive paper of this embodiment can be used as a crimped postcard used with secret information notifications (invoices, various types of notifications) or the like, for example. FIGS. 2A-2D are drawings showing the manufacturing procedure for crimped postcards (one example of adhesive paper).

First, as shown in FIG. 2A, secret information SI is printed on the paper P manufactured using the paper manufacturing apparatus 100. For the printing of the secret information SI, an inkjet printer using pigmented ink, dye ink or the like is used. Next, as shown in FIG. 2B, the paper P on which the secret information SI is printed has the surface on which the secret information SI is printed folded to the inside. Next, as shown in FIG. 2C, the entire surface of the paper P in a folded state is heated and pressurized by the heating a pressurization means HP (heated roller or the like), and the papers are adhered to each other. By doing the above, it is possible to manufacture a crimped postcard PP. As shown in FIG. 2D, the person who receives the crimped postcard PP is able to confirm the secret information by peeling the adhesion surface by hand.

Here, we described an example of manufacturing adhesive paper by heating and pressurizing one sheet of paper P in a folded state and adhering it, but it is also possible to manufacture adhesive paper by heating and pressurizing two sheets of paper P to each other to adhere them. Also, the adhesive paper of the present invention is not limited to being adhesive paper for which the entire paper P is heated and pressurized to adhere papers P to each other, but also includes adhesive paper in a state for which a plurality of papers P are in a bound state by partially adhering the papers P to each other by heating and pressurizing a portion of the surface of the paper P. When working in this way, it is possible to bind the plurality of papers P without using a stapler, clip or the like. It is also possible to peel the plurality of papers P one sheet at a time. The peeled paper P contains thermoplastic resin, so it is also possible to again heat and pressurize and to adhere and peel.

With the adhesive paper of this embodiment, using paper P formed by bonding a plurality of fibers via resin, the papers P are adhered to each other by a portion of the resin that bonds the fibers to each other being fused by heating, so it is possible to adhere the papers to each another without requiring a special step such as forming an adhesion layer on the paper surface (coating a paste, crimping a film, or coating a varnish), and to realize an adhesive paper for which peeling is also possible.

### 3. Modification Example

The present invention includes constitutions that are essentially the same as the constitutions described with the embodiments (constitutions for which the function, method and results are the same, or constitutions for which the purpose and effect are the same). Also, the present invention includes constitutions that exhibit the same operational effects or constitutions for which it is possible to achieve the same objects as the constitutions described with the embodiments. The present invention also includes constitutions for which known technology is added to the constitutions described with the embodiments.

The paper manufactured using the paper manufacturing apparatus 100 includes a mode of forming a thin sheet form using pulp or used paper as the raw material, and includes recording paper for the purpose of note taking or printing, and wallpaper, wrapping paper, colored paper, drawing paper, Kent paper or the like. As the raw material, it is possible to use plant fibers such as cellulose or the like, or animal fibers such as sheep wool, silk or the like.

It is also possible to provide a water spraying device for spraying and adding moisture to the deposited material deposited on the deposition unit 72. By doing this, it is possible to increase the strength of the hydrogen bond when forming the paper P. The spraying and adding of the moisture is performed on the deposited material before it passes through the heater roller 76. Starch, PVA (polyvinyl alcohol) or the like can also be added to the moisture sprayed using the water spraying device. By doing this, it is possible to further strengthen the paper P.

It is also possible to not have the crushing unit 10 on the paper manufacturing apparatus 100. For example, if an item pulverized using an existing shredder or the like is used as the raw material, the crushing unit 10 is unnecessary.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An adhesive paper for which paper formed by a plurality of fibers being bonded via resin is heated and adhered together and which is peelable.

2. The adhesive paper according to claim 1, wherein
the resin is dispersed in a thickness direction of the paper, and no adhesion layer exists on a surface of the paper.

3. The adhesive paper according to claim 1, wherein
a portion of the resin is used to adhere the paper.

4. The adhesive paper according to claim 1, wherein
a volume of the resin to the fibers is 8 to 40%.

5. A manufacturing method of an adhesive paper for which paper formed by a plurality of fibers being bonded via resin is heated and adhered together.
